(19) United States
(12) Patent Application Publication
(10) Pub. No.: US 2025/0148149 A1
(43) Pub. Date: May 8, 2025

(54) PARAMETER OPTIMIZATION METHOD FOR NONLINEAR VIBRATION MODEL OF COMPLEX DEVICE

(71) Applicant: NANJING UNIVERSITY OF POSTS AND TELECOMMUNICATIONS, Jiangsu (CN)

(72) Inventors: Haigen YANG, Jiangsu (CN); Hao DING, Jiangsu (CN); Xu BAI, Jiangsu (CN); Qianqian HUANG, Jiangsu (CN)

(73) Assignee: NANJING UNIVERSITY OF POSTS AND TELECOMMUNICATIONS, Jiangsu (CN)

(21) Appl. No.: 18/839,025

(22) PCT Filed: Oct. 11, 2023
(86) PCT No.: PCT/CN2023/124014

§ 371 Date: Aug. 16, 2024

(30) Foreign Application Priority Data
Oct. 10, 2022 (CN) 202211233755.7

(51) Int. Cl. G06F 30/15; G06F 30/27; G06F 111/04

(52) U.S. Cl. CPC G06F 30/15; G06F 30/27; G06F 2111/04

(57) ABSTRACT

Parameter optimization method for nonlinear vibration model of complex device, comprising: 1) constructing various structures of complex device into tree structure, to form tree-shaped complex device model subsystem, and carrying out sign convention for dynamic analysis; 2) establishing complex device dynamic model to obtain dynamic relationships among all parts of complex device; 3) according to contact and collision conditions in advancing process of physical complex device, adding constraint relationships among parts in dynamic simulation software; 4) on basis of dynamic simulation software, establishing virtual prototype model of complex device, and determining target parameter and optimization target; 5) simulating vibration characteristics of complex device for different levels of pavement spectrums and different vehicle speeds; 6) adding required input point and output point for virtual prototype model; 7) on basis of optimization algorithm of numerical solution in small sample deep learning, obtaining optimal parameter.

### TECHNICAL FIELD

The present invention relates to the technical field of equipment simulation, and particularly relates to a parameter inversion and optimization method for a nonlinear vibration model of a complex device.

### BACKGROUND

With the continuous advancement of science and technology and the development of information technology, structures of complex device such as tanks and tracked vehicles are becoming increasingly sophisticated, and vibration damping performance of these tracked vehicles directly affects their smoothness and maneuverability. Optimizing the design of these structures has become an important means to improve their transportation capabilities and other performance.

Small sample deep learning has very strong fitting capabilities, but it lacks good learning capability like human beings when only a small number of training samples is available. Since it is very expensive or difficult to obtain training samples in some scenarios, a concept of small sample learning accordingly came into being, which aims to achieve high-precision target detection with a very small number of samples, enhance the generalization performance of a machine learning model and improve the inferential capability thereof. Generalization performance refers to the capability of a machine learning algorithm to adapt to new samples.

### SUMMARY

A technical problem to be solved by the present invention is: how to improve the vibration damping performance of a complex device system.

In order to implement the above object, the present invention adopts a following technical solution:

A parameter optimization method for a nonlinear vibration model of a complex device, including following steps:
1) constructing various parts of the complex device into a tree structure according to a principle of multi-body system dynamics, to form a tree-shaped complex device part model, and carrying out sign convention for dynamic analysis;
2) establishing a complex device dynamic model to determine connection modes and constraint relationships among the parts;
3) adding the constraint relationships among the parts in a dynamic simulation software according to contact and collision conditions in the advancing process of the complex device;
4) establishing a virtual prototype model of the complex device, and determining a target parameter and an optimization target on the basis of the dynamic simulation software;
5) simulating vibration characteristics of the complex device for different levels of pavement spectra and different vehicle speeds;
6) adding a required input point and an output point for the virtual prototype model, that is, the target parameter and the optimization target to be optimized; and
7) fitting the data set generated in the simulation process through a neural network according to the optimization target, and performing a plurality of iterations by using a stochastic gradient descent method to obtain a global optimal solution.

Beneficial effects: the present invention simulates the nonlinear vibration model of complex device to obtain nonlinear vibration parameters of the complex device model, optimizes the structural parameters of the complex device system based on small sample deep learning, and effectively reduces the vibration acceleration of the complex device model. The traditional manufacturing method has the disadvantages of long cycle, inconvenient optimization and the like. The present invention adopts inversion and optimization method to reasonably simplify the structure of the complex device, thereby greatly reducing the manufacturing cost.

### BRIEF DESCRIPTION OF THE DRAWINGS

FIG. 1 is a flow chart of a parameter inversion and optimization method for a nonlinear vibration model of a complex device according to an embodiment of the present invention.

FIG. 2 is a flow chart of an optimization algorithm based on small sample deep learning according to an embodiment of the present invention.

FIG. 3 is a tree structure diagram of some parts of a complex device according to an embodiment of the present invention.

### DESCRIPTION OF THE EMBODIMENTS

The present invention will be further described below with reference to the accompanying drawings. The following embodiments are merely used to more clearly describe the technical solutions of the present invention, instead of limiting the scope of protection of the present invention.

### Embodiment 1

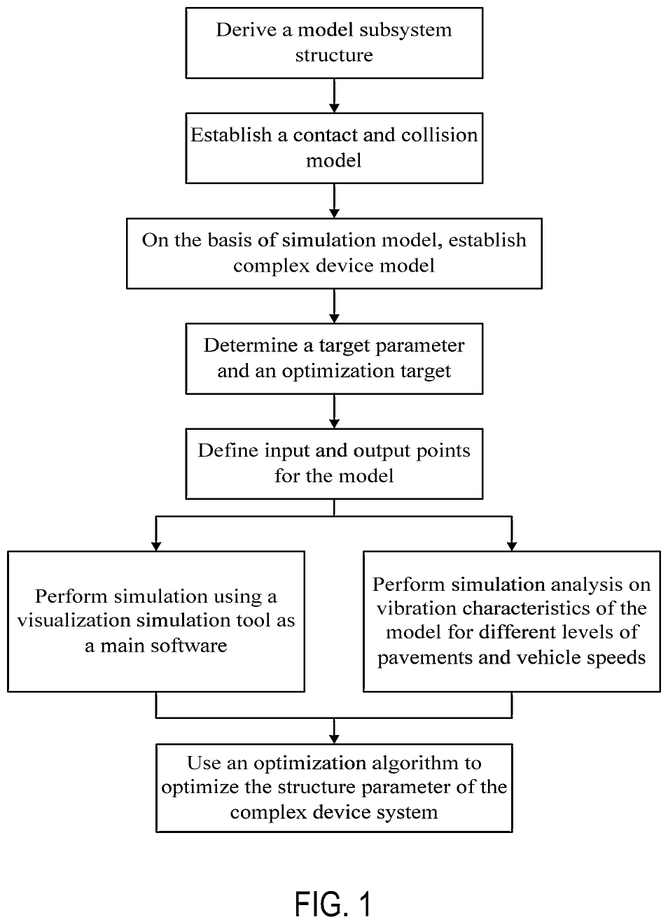

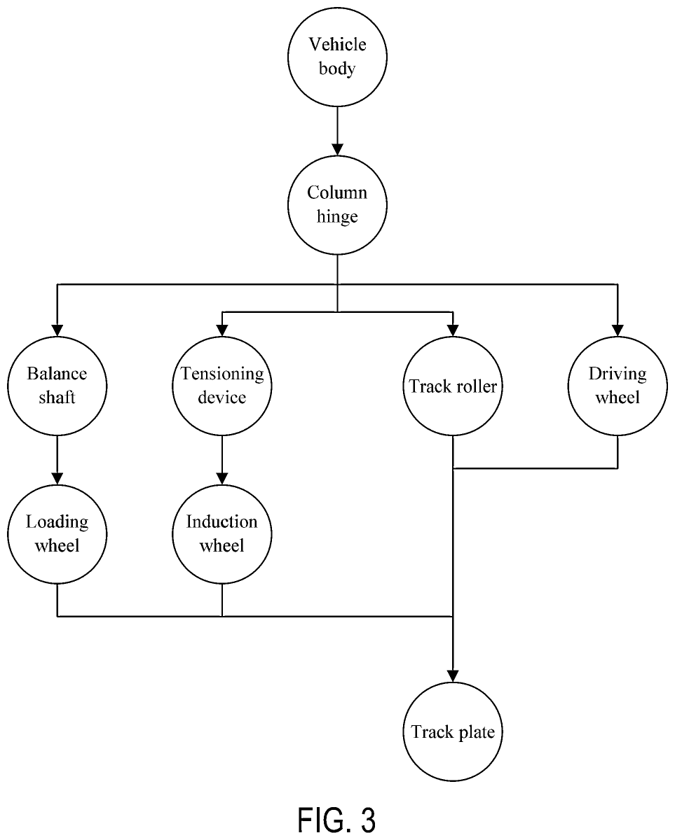

As shown in FIG. 1, a parameter optimization method for a nonlinear vibration model of a complex device provided by the present invention, including following steps:
1) constructing various parts of the complex device into a tree structure, as shown in FIG. 3, according to a principle of multi-body system dynamics, to form a tree-shaped complex device part model, and carrying out sign convention for dynamic analysis; the various parts include a driving wheel, an induction wheel, a loading wheel, a riding wheel bracket, a suspense device, a track plate, and the like, of a tracked vehicle, where the driving wheel, the induction wheel and the loading wheel are all connected to the track plate, and the riding wheel bracket is connected to the loading wheel and the induction wheel, respectively;
2) establishing a complex device dynamic model to determine connection modes and constraint relationships among the parts;
3) adding the constraint relationships among the parts in a dynamic simulation software according to contact and collision conditions in the advancing process of the complex device;
4) establishing a virtual prototype model of the complex device, and determining a target parameter and an optimization target on the basis of the dynamic simulation software;
5) simulating vibration characteristics of the complex device for different levels of pavement spectra and different vehicle speeds;
6) adding a required input point and an output point for the virtual prototype model, that is, the target parameter and the optimization target to be optimized; and
7) fitting the data set generated in the simulation process through a neural network according to the optimization target, and performing a plurality of iterations by using a stochastic gradient descent method to obtain a global optimal solution.

Further, in the step 1), the sign convention for dynamic analysis includes:
convention for the parts of the complex device: a part with mass is defined as a body element, and a part without mass is a defined as a hinge element; and
convention for the input and output points: variable conditions, such as a speed and a torque, each is defined as the input points, the target parameter is defined as the output point, and a path direction from the input point to the output point is a transmission direction.

Further, in the step 2), in the process of establishing a complex device dynamic model, connection modes and constraint relationships among the parts are determined by using the relationships among parts of a physical tracked vehicle in the advancing process and a static environment; where the constraint relationships include revolute pairs among a vehicle body, the driving wheel, the induction wheel and a track roller, as well as a contact relationship between a pavement and the track plate, and the various parts of the tracked vehicle are connected and assembled in the dynamic simulation software. RecurDyn, ADAMS and the like can be selected and used as the dynamic simulation software.

Further, in the step 3), the constraint relationships among the parts is used to determine the influence of load force on the parts, and the model can be accurately simulated by applying constraint conditions; when the complex device is the tracked vehicle and taken as an example, “determine connection modes and constraint relationships among the parts” in the step 2) is added in the dynamic simulation software, the revolute pair is selected through a toolbar thereof to enter a selection mode, and mass center maker points of the driving wheel, the induction wheel, the track roller and the like are selected in sequence, “Ground” is selected as a “Base Maker”, indicating that the revolute pair is successfully added; and a prismatic pair is added for the suspense device at the same time by using the same method, the contact relationship between the pavement and the track plate can be automatically added when the track plate is assembled, and the revolute pair added on the driving wheel of the tracked vehicle can be used as driving force.

Further, in the step 4), the target parameter of the complex device includes mass center vibration accelerations of and force imposed on the vehicle body under different stiffnesses and dampings, different levels of pavement spectra and different advancing speeds, and the optimization target is to minimize the mass center vibration acceleration.

Further, in the step 5), the pavement spectrum involves a pavement unevenness calculation program written based on a mathematical tool, a spatial pavement frequency n (n₁<n<n₂) is averagely divided into N intervals according to the calculation program, a power spectral density value G(δᵢ) corresponding to a center frequency σᵢ (i=1, 2, . . . , N) of each interval is taken to replace a Δn value of a corresponding interval range, where the interval range is Δn=n₂−n₁/N, the obtained power spectral densities are written as the pavement spectrum by using the mathematical tool, MATLAB and the like can be used as the mathematical tool, and the written pavement spectrum is exported in an .rdf format, which can be imported into an interface of Ground of the dynamic simulation software.

Further, in the step 5), in the process of simulating vibration characteristics of the complex device for different levels of pavement spectra and different vehicle speeds, the virtual prototype model imposed with the constraint conditions is pre-simulated in the dynamic simulation software, driving force is applied to the virtual prototype model through attributes of the revolute pair, a mass center vertical acceleration curve graph is obtained through the defined output point in a running state of the virtual prototype model, and a root-mean-square values of a mass center vertical acceleration is calculated using a following formula:

$$a = \sqrt{\frac{{\sum }_{i = 1}^{n} {b}_{i}^{2}}{t}}$$

in the formula, bᵢ represents the mass center vertical acceleration, a represents the root-mean-square value of the mass center vertical acceleration, and t represents a number of data.
a driving road includes a hard road and a soft road, where the hard road is used to check terrain trafficability, the soft road is used to check ground trafficability, and the power spectral density G(n) of the pavement unevenness is fitted by using a following formula:

$$G ( n ) = G ( {n}_{0} ) {( \frac{n}{{n}_{0}} )}^{- w}$$

in the formula, n represents a spatial frequency; no represents a spatial reference frequency; G(n₀) represents a pavement power spectral density value under n₀, which is referred to as a pavement unevenness coefficient; and w is a frequency index, which determines a frequency structure of the pavement power spectral density.

Further, in the step 6), in the process of adding a required input point and an output point for the virtual prototype model, the input point and the output point are defined in the virtual prototype model imposed with the constraint conditions in the dynamic simulation software; variable conditions, such as a speed and a torque, each is defined as the input point, a mass center vertical acceleration of the complex device is defined as the output point, the virtual prototype model capable running in the dynamic simulation software is exported through a column of “Control”, a packaged file of the virtual prototype model is connected to a Constant module, a Scope module and the like in a control tool, a numerical value is inputted to the input point for simulation, and results are viewed in the output point.

Further, in the step 7), in the process of obtaining an optimal parameter, the root-mean-square value of the mass center vertical acceleration of the complex device dynamic model is taken as the optimization target, and data sets generated in the simulation process include stiffness and damping, an advancing speed of the complex device dynamic model, and the outputted mass center vertical acceleration of the complex device; and since it is very difficult to obtain the data sets, an optimization algorithm of numerical solution in small sample deep learning is adopted to expand the data sets through a generative adversarial network, and the expanded data sets are fitted through a fully connected neural network, and are then subjected to the plurality of iterations by using the stochastic gradient descent method to obtain the global optimal solution.

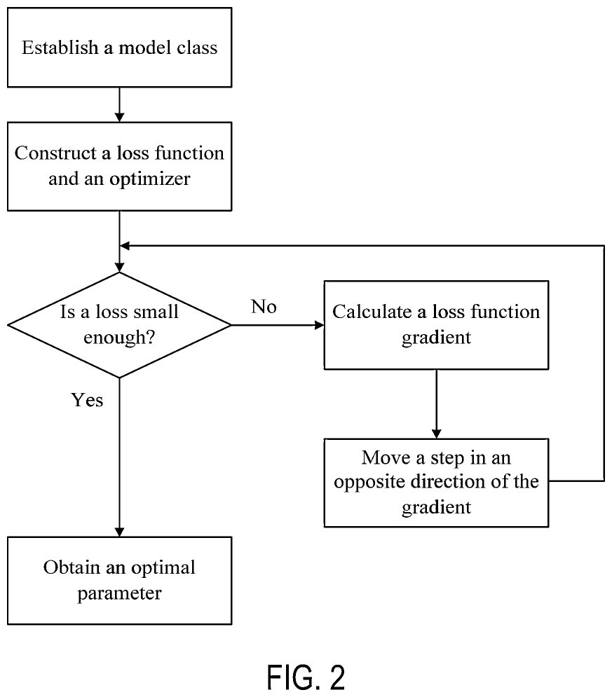

As shown in FIG. 2, a model class is established in a code editor, the model class inherits an nn.module class, including a constructor and a feedforward network, the constructor is used to call a module integrated in the nn.module class, the nn.module class is called to construct an object, and the object includes a weight and a bias, and dimensions of inputted samples and outputted samples; MSELoss and optim of a torch module are called in the feedforward network to construct a loss function and an optimizer, an object of the constructor is operated, the root-mean-square value of the mass center vertical acceleration is taken as the optimization target, data of a simulation input point is taken as a training model, feedback operation is performed on an instantiated model class, the weight and the bias are updated, and the above operation is repeated until the loss reaches a set value, that is, the purpose of finding the optimal parameter is achieved.

The above embodiments are merely intended for description of, rather than limitation to, the technical solutions of the present invention. Those of ordinarily skilled in the art should understand that they may still make modifications or equivalent replacements to the specific embodiments present invention without departing from the spirit and scope of the technical solutions of the present invention, all of which should be encompassed within the protection scope of the claims of the present invention.

1. A parameter optimization method for a nonlinear vibration model of a complex device, comprising following steps:
1) constructing various parts of the complex device into a tree structure according to a principle of multi-body system dynamics, to form a tree-shaped complex device part model, and carrying out sign convention for dynamic analysis;
2) establishing a complex device dynamic model to determine connection modes and constraint relationships among the parts;
3) adding the constraint relationships among the parts in a dynamic simulation software according to contact and collision conditions in an advancing process of the complex device;
4) establishing a virtual prototype model of the complex device, and determining a target parameter and an optimization target on a basis of the dynamic simulation software;
5) simulating vibration characteristics of the complex device for different levels of pavement spectra and different vehicle speeds;
6) adding a required input point and an output point for the virtual prototype model, that is, the target parameter and the optimization target to be optimized; and
7) fitting a data set generated in a simulation process through a neural network according to the optimization target, and performing a plurality of iterations by using a stochastic gradient descent method to obtain a global optimal solution.

2. The parameter optimization method for the nonlinear vibration model of the complex device according to claim 1, wherein in the step 1), the sign convention for dynamic analysis comprises:
convention for the parts of the complex device: a part with mass is defined as a body element, and a part without mass is a defined as a hinge element; and
convention for the input and output points: a variable condition is defined as the input point, the target parameter is defined as the output point, and a path direction from the input point to the output point is a transmission direction.

3. The parameter optimization method for the nonlinear vibration model of the complex device according to claim 1, wherein in the step 1), the various parts comprises a driving wheel, an induction wheel, a loading wheel, a riding wheel bracket, a suspense device, and a track plate of a tracked vehicle, wherein the driving wheel, the induction wheel and the loading wheel are all connected to the track plate, and the riding wheel bracket is connected to the loading wheel and the induction wheel, respectively.

4. The parameter optimization method for the nonlinear vibration model of the complex device according to claim 1, wherein in the step 2), in the process of establishing the complex device dynamic model, the connection modes and the constraint relationships among the parts are determined by using the relationships among parts of a physical tracked vehicle in the advancing process and a static environment.

5. The parameter optimization method for the nonlinear vibration model of the complex device according to claim 1, wherein in the step 3), when the complex device is the tracked vehicle, “determine connection modes and constraint relationships among the parts” in the step 2) is added in the dynamic simulation software, a revolute pair is selected through a toolbar thereof to enter a selection mode, and mass center maker points of a driving wheel, an induction wheel, a track roller and the like are selected in sequence, “Ground” is selected as a “Base Maker”, indicating that the revolute pair is successfully added; and a prismatic pair is added for a suspense device at the same time, and a contact relationship between a pavement and a track plate can be automatically added when the track plate is assembled.

6. The parameter optimization method for the nonlinear vibration model of the complex device according to claim 1, wherein in the step 4), the target parameter of the complex device comprises mass center vibration accelerations of and force imposed on a vehicle body under different stiffnesses and dampings, different levels of pavement spectra and different advancing speeds, and the optimization target is to minimize the mass center vibration accelerations.

7. The parameter optimization method for the nonlinear vibration model of the complex device according to claim 1, wherein in the step 5), in the process of simulating vibration characteristics of the complex device for different levels of pavement spectra and different vehicle speeds, the virtual prototype model imposed with constraint conditions is pre-simulated in the dynamic simulation software, a driving force is applied to the virtual prototype model through attributes of a revolute pair, a mass center vertical acceleration curve graph is obtained through the defined output point in a running state of the virtual prototype model, and a root-mean-square values of a mass center vertical acceleration is calculated using a following formula:
$$a = \sqrt{\frac{{\sum }_{i = 1}^{n} {b}_{i}^{2}}{t}}$$
in the formula, bᵢ represents the mass center vertical acceleration, a represents the root-mean-square value of the mass center vertical acceleration, and t represents a number of data.

8. The parameter optimization method for the nonlinear vibration model of the complex device according to claim 7, wherein a driving road comprises a hard road and a soft road, wherein the hard road is used to check terrain trafficability, the soft road is used to check ground trafficability, and a power spectral density G(n) of a pavement unevenness is fitted by using a following formula:
$$G ( n ) = G ( {n}_{0} ) {( \frac{n}{{n}_{0}} )}^{- w}$$
in the formula, n represents a spatial frequency; no represents a spatial reference frequency; G(n₀) represents a pavement power spectral density value under n₀, which is referred to as a pavement unevenness coefficient; and w is a frequency index, which determines a frequency structure of the pavement power spectral density.

9. The parameter optimization method for the nonlinear vibration model of the complex device according to claim 1, wherein in the step 6), in the process of adding the required input point and the output point for the virtual prototype model, the input point and the output point are defined in the virtual prototype model imposed with constraint conditions in the dynamic simulation software; the virtual prototype model capable running in the dynamic simulation software is exported through a column of “Control”, a packaged file of the virtual prototype model is connected to a Constant module, and a Scope module in a control tool, a numerical value is inputted to the input point for simulation, and results are viewed in the output point.

10. The parameter optimization method for the nonlinear vibration model of the complex device according to claim 1, wherein in the step 7), in the process of obtaining an optimal parameter, the root-mean-square value of a mass center vertical acceleration of the complex device dynamic model is taken as the optimization target, and data sets generated in the simulation process comprise stiffness and damping, an advancing speed of the complex device dynamic model, and the outputted mass center vertical acceleration of the complex device; and an optimization algorithm of numerical solution in small sample deep learning is adopted to expand the data sets through a generative adversarial network, and the expanded data sets are fitted through a fully connected neural network, and are then subjected to the plurality of iterations by using the stochastic gradient descent method to obtain the global optimal solution.
